(19) United States
(12) Patent Application Publication
(10) Pub. No.: US 2005/0226622 A1
(43) Pub. Date: Oct. 13, 2005

(54) Underwater repeater employing rare earth element doped fiber amplifier, Raman assist and optical pump source sparing

(75) Inventors: Patrick R. Trischitta, Holmdel, NJ (US); Koji Goto, Saitama (JP); Hidenori Taga, Sakado-Shi (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: KDDI Submarine Cable Systems Inc., Tokyo (JP)

(21) Appl. No.: 10/818,888

(22) Filed: Apr. 6, 2004

(51) Int. Cl. H04J 14/02

(52) U.S. Cl. 398/92

(57) ABSTRACT

An optical repeater is provided which is operable to amplify signals propagated by a pair of optical transmission fibers. The optical repeater includes a first rare earth element doped (REED) fiber coupled to a first transmission fiber of the pair of optical transmission fibers. A second rare earth element doped (REED) fiber is coupled to a second transmission fiber of the pair of optical transmission fibers. A plurality of optical pump sources are provided, there being either four or more pump sources, or at least two pump sources in which each pump source has a different center wavelength. One or more optical energy couplers are coupled to combine portions of the outputs of all the optical pump sources and to distribute the combined portions for insertion into each of the first and second REED fibers for amplification of signals and into each of the first and second transmission fibers for Raman amplification of signals.

### BACKGROUND OF THE INVENTION

The present invention relates to optical communication systems.

Long-haul optical communication networks, such as those which carry optical signals across continents or across oceans and other large bodies of water, commonly utilize transmission fibers which are interrupted by optical signal amplifiers referred to as “repeaters” at appropriate intervals, the intervals typically measuring in distances of several tens of miles.

The long-haul transmission of optical signals over optical transmission fibers, including in undersea transmission systems, has greatly benefited over the last fifteen years by the introduction of rare earth element doped (hereinafter, “REED”) fiber amplifiers, among which are erbium doped fiber amplifiers (EDFAs). Such EDFAs and other REED fiber amplifiers are advantageously used in optical repeaters because they do not require conversion of optical signals into electrical signals for amplification and vice versa.

Existing EDFAs are used to amplify signals over wavelengths ranging between about 1530 nm and 1560 nm. FIG. 1 illustrates an EDFA repeater 10. The repeater 10 includes a section of an erbium doped optical fiber 12. The erbium doped optical fiber 12 is coupled to receive optical signals from an incoming optical transmission fiber 14, of which a section thereof is shown. The erbium doped fiber 12 is further coupled to an outgoing optical transmission fiber 18 through an optical isolator 20. A plurality of optical signals are typically multiplexed on the transmission fiber as wavelength-division multiplexed signals. The repeater 10 further includes an optical pump source 16, such as a laser, laser diode or light emitting diode outputting optical energy within a narrow range of wavelengths centered at about 980 nm. The output of the pump source 16 is coupled to the section 12 of erbium doped fiber through an optical coupler 22. Amplification of the optical signal is produced when optical energy from the pump source 16 is injected into the section 12 of the erbium doped fiber over which the signals are carried.

The repeater 10 illustrated in FIG. 1 has a problem in that it has only a single active component, the pump source 16. This makes it such that any failure of the pump source will cause the repeater to be inoperative. Stated another way, failure of the pump source results in the repeater changing from amplifying the optical signals with significant gain to causing significant loss. If such repeater 10 were used in a remote location of a long-haul transmission link, such as in an undersea link and the pump source 16 were to fail, that link would become inoperative. In such case, the transmission fiber would have to be raised from the sea bed and repaired. Clearly, such result would be costly to handle, and must be avoided.

In remote locations such as undersea links, it is essential that the pump source 16 of the repeater 10 be sufficiently reliable to provide uninterrupted amplification for up to 25 years. Undersea systems are difficult to repair and are required to have nearly 100 percent availability over the entire service life of the system, which is typically about 25 years. Accordingly, it would be desirable to provide a repeater in which the pump source 16 is selected based on high reliability.

FIG. 2 illustrates a configuration of a prior art repeater 30, disclosed in U.S. Pat. No. 5,173,957 which has been used in most undersea repeaters manufactured worldwide since the early 1990's. The repeater 30 differs from the repeater 10 discussed above in that it includes a pair of EDFAs operable to amplify the optical signals on a pair of optical transmission fibers 34, 35, which are arranged to carry optical signals in directions opposite from each other. In such prior art repeater 30, the same pump sources 36, 37 supply optical pump energy to two sections 32, 33 of erbium doped fiber for amplification. The two pump sources 36, 37, each having the same nominal power output, supply optical pump energy to a 3 dBV coupler 40 where the energy from both pump sources 36 and 37 is combined. Half (“half” is expressed as “3 dB” in terminology relating to power) of the combined output is output by the coupler 40 onto a first directional coupler 42. Ultimately, the output onto coupler 42 includes half of the power from pump source 36, and half of the power from pump source 37, such that the combined energy output onto coupler 42 is equivalent to the power output from one of the pump sources 36 or 37, when both sources 36, 37 have the same output power. When the two sources 36, 37 have different power output levels, the average of the two power output levels is outputted by coupler 40 onto each of the directional couplers 42, 44. The other half of the combined output power, also equivalent to the power output of one of the sources 36, 37 is output by the coupler 40 onto a second directional coupler 44.

Owing to such arrangement of combining the power from two optical pump sources 36 and providing half of the output power to each of the two EDFAs of the repeater 30, the repeater 30 is tolerant of failure. If a pump source 36 fails, one functioning pump source 37 still remains, such that both directional couplers 42, 44 are supplied by the remaining pump source 37 through the 3 dB coupler. However, each directional coupler 42, 44 is powered only at a level equivalent to half the output power of the remaining source 37.

Another development is the use of Raman amplification in some types of optical communication systems. Raman amplification operates by injecting optical energy at a point generally at the end of an optical transmission fiber. As shown in FIG. 3, energy from an optical pump source (typically laser, or laser diode but permissibly light emitting diode) is coupled into the optical transmission fiber 54 by way of a directional coupler 52. Given a sufficiently long length of the optical transmission fiber, amplification is produced.

The optical pump energy can be coupled into the fiber 54 in the “upchannel” or reverse direction (the direction against the direction of signal propagation) as shown in FIG. 3. In such case, the signals grow stronger as they approach the location where the pump energy is coupled to the fiber 54. Such use of Raman amplification can provide gain of one or more orders of magnitude for low power signals such as those heading towards the source 56 from a long segment of a transmission fiber (e.g. several tens of kilometers). Alternatively, the optical pump energy can be coupled into the fiber 54 in the “downchannel” direction, i.e., in the direction of signal propagation, opposite to that shown in FIG. 3. The pump source 56 used for Raman amplification outputs energy which is substantially centered at one wavelength. Raman assist amplification works best when the optical pump source 56 has a wavelength of nominally 1480 nm, that being a wavelength to which the optical transmission fiber is more sensitive.

In order for undersea systems to utilize Raman amplification, the laser pumps used therefor must be sealed in watertight vessels capable of withstanding the extreme pressure of the undersea or ocean floor environment. It would be desirable to provide an optical repeater adapted to produce both Raman amplification and amplification from an erbium doped fiber amplifier in which a water tight vessel need only be provided for a single group of optical pump sources which powers both types of amplification.

An existing challenge of the prior art is to provide an optical repeater for use in wave-division multiplexed transmission systems which has a consistent flat gain profile over the range of transmitted wavelengths in such multiplexed system. Single pump sources tend to be narrowband, favoring wavelengths that are close to the center wavelength and rejecting wavelengths that are more distantly spaced from the center wavelength. However, multiple pump sources multiply the cost of the repeater, if multiple pump sources are to be provided for powering each EDFA and each transmission fiber for Raman amplification. In addition, when multiple pump sources are to be provided each having a predetermined different wavelength, it can be both difficult and costly to obtain the exact wavelength for each pump source. For example, U.S. Pat. No. 6,388,806 B1 (“the '806 patent”) describes combining the outputs of several pump sources at different center wavelengths near 1480 nm and then providing the combined output either to different stages of a multi-stage amplifier (FIG. 1) or for Raman amplification 52 (FIG. 8). In the '806 patent, the power from the same set of pumps having different center wavelengths is not combined to provide power to both an EDFA and for Raman amplification.

Particular prior art describes combining the outputs of multiple pump sources and coupling portions of the combined output to EDFAs and to an optical transmission fiber. U.S. Pat. No. 6,204,960 B1 to Desurvire issued Mar. 20, 2001 (“the '960 patent”) describes repeaters in which the outputs of a plurality of pump sources are combined and then distributed by way of couplers into one or more erbium doped fibers for EDFA amplification, and into transmission fibers for distributed amplification. However, the 1960 Patent describes such system only in the context of transmitting a special type of signal known as solitons. In addition, in the case of each repeater, the outputs of no more than two pump sources are combined together by the same coupler, and the outputs of no more than three pump sources are combined for input to an EDFA or to a particular transmission fiber. Moreover, the system described in the '960 patent places no requirements on the pump sources and their center wavelengths, as used in each repeater.

It would be desirable to provide a repeater in which portions of the outputs of at least four pump sources are all combined and the combined portions then distributed to each of at least two erbium doped fibers and to each of at least two transmission fibers.

It would further be desirable to provide a repeater in which outputs of a plurality of pump sources are combined and distributed in the above manner, wherein each of the pump sources has a different center wavelength.

### SUMMARY OF THE INVENTION

Therefore, according to an aspect of the invention, an optical repeater is provided which is operable to amplify signals propagated by a pair of optical transmission fibers. The optical repeater includes a first rare earth element doped (REED) fiber coupled to a first transmission fiber of the pair of optical transmission fibers. A second rare earth element doped (REED) fiber is coupled to a second transmission fiber of the pair of optical transmission fibers. According to such aspect of the invention, at least four optical pump sources are provided. One or more optical energy couplers are coupled to combine outputs of all the optical pump sources and to distribute the combined portions for insertion into each of the first and second REED fibers for amplification of signals and into each of the first and second transmission fibers for Raman amplification of signals.

According to another aspect of the invention, an optical repeater is provided which is operable to amplify signals propagated by a pair of optical transmission fibers. The optical repeater includes a first rare earth element doped (REED) fiber coupled to a first transmission fiber of the pair of optical transmission fibers. A second rare earth element doped (REED) fiber is coupled to a second transmission fiber of the pair of optical transmission fibers. According to such aspect of the invention, a plurality of optical pump sources are provided, in which each pump source has a center wavelength which is different from that of any other of the optical pump sources. An optical energy coupler is coupled to combine outputs of the optical pump sources and to distribute the combined portions for insertion into each of the first and second REED fibers for amplification of signals and into each of the first and second transmission fibers for Raman amplification of signals.

### BRIEF DESCRIPTION OF THE DRAWINGS

FIG. 1 is a block and schematic diagram illustrating an optical repeater including an erbium doped fiber amplifier according to the prior art.

FIG. 2 is a block and schematic diagram illustrating an optical repeater including a pair of erbium doped fiber amplifiers according to the prior art.

FIG. 3 is a block and schematic diagram illustrating a Raman amplifier according to the prior art.

FIG. 4 is a block and schematic diagram illustrating an optical repeater according to an embodiment of the invention.

FIG. 5 is a graph illustrating a pumping power output of a pump source, such as utilized in optical repeaters according to embodiments of the invention.

FIG. 6 is a graph illustrating pumping power outputs of a plurality of pump sources having different center wavelengths, such as utilized in optical repeaters according to embodiments of the invention.

FIG. 7 is a block and schematic diagram illustrating an optical repeater according to another embodiment of the invention.

FIG. 8 is a block diagram illustrating an optical transmission network according to an embodiment of the invention.

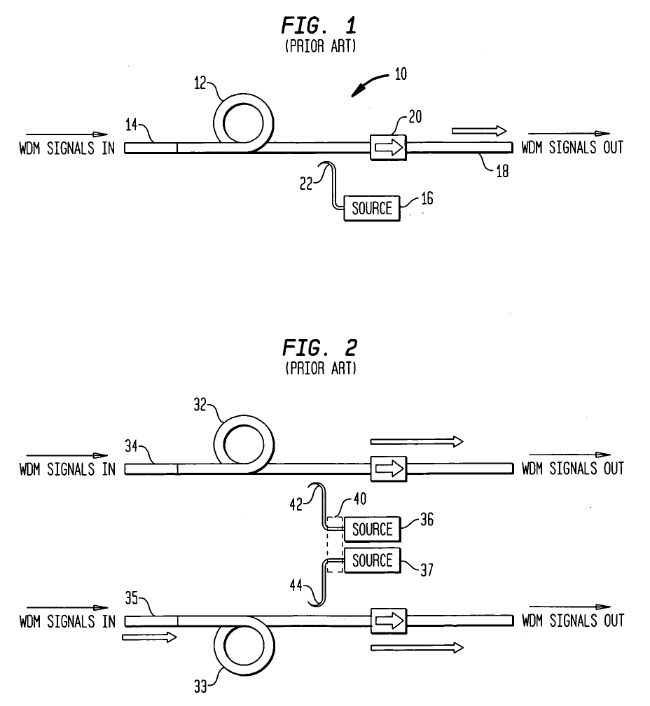

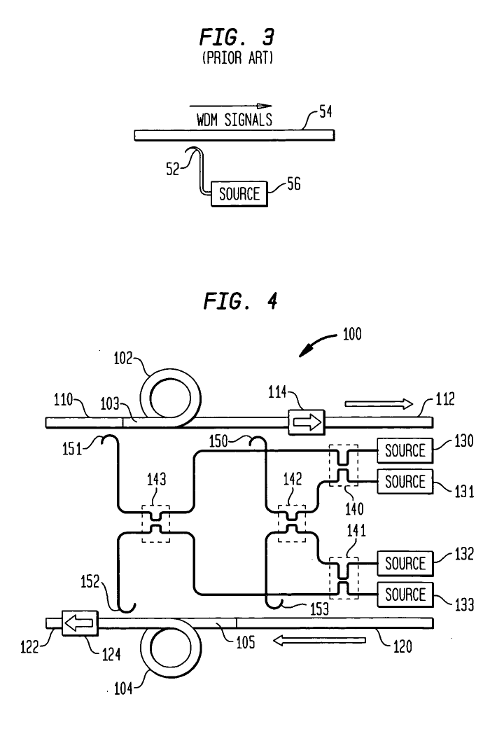

### DETAILED DESCRIPTION

The embodiments of the invention will now be described with reference to FIGS. 4 through 8.

An optical repeater 100 according to a first preferred embodiment of the invention is shown in FIG. 4. The repeater 100 includes first and second optical fiber sections 102 and 104, respectively, each of which is doped with a rare earth element, which is preferably erbium. The repeater is shown coupled to optical transmission fibers 110, 112, 120 and 122 for amplifying optical signals carried on the fibers. In the particular embodiment shown in FIG. 4, optical transmission fibers 110 and 112 are arranged to propagate optical signals in a first direction, while optical transmission fibers 120 and 122 are arranged to carry optical signals in a second direction opposite to the first direction.

The first erbium doped fiber section 102 is inserted into the path of a first input optical transmission fiber 110. The output of the first erbium doped fiber section 102 is coupled to a first output optical transmission fiber 112 through an isolator 114. The second erbium doped fiber section 104 is inserted into the path of a second input optical transmission fiber 120. The output of the second erbium doped fiber section 104 is coupled to a second output optical transmission fiber 122 through an isolator 124.

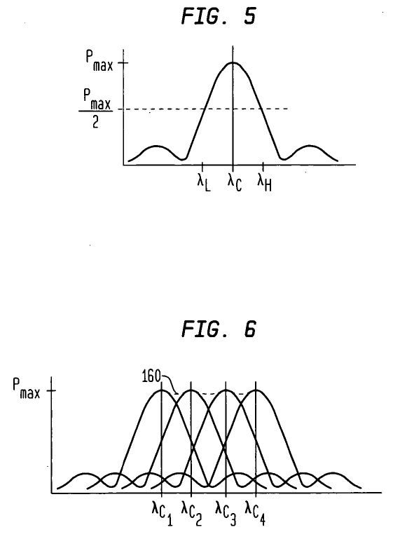

The repeater 100 also includes four optical pump sources 130, 131, 132, and 133, which are coupled to supply optical energy for pumping the first and second doped fiber sections 102, and 104 and the input transmission fibers 110, 120. The optical pump sources are desirably lasers, or alternatively laser diodes, having the following exemplary characteristics: output power of 500 W, and nominal center wavelength λ_{C} disposed between 1460 and 1480 nm. With reference to FIG. 5, each pump source has an upper 3 dB wavelength λ_{H} above the center wavelength λ_{C} and a lower 3 dB wavelength λ_{L} below the center wavelength λ_{C}. The 3 dB wavelengths are the wavelengths at which the power level is down 50% from the peak power level Pₘₐₓ at the center wavelength λ_{C}. The range of wavelengths between the upper and lower 3 dB wavelengths can vary, depending upon the particular type of pump source and its manufacture. However, it is characteristic of laser and laser diode pump sources for the optical energy output to be confined to a relatively narrow range of wavelengths.

Portions of the output of all four optical pump sources 130-133 are combined and distributed four ways onto optical couplers 150-153, by an arrangement of 3 dB couplers 140-143. Each of the optical couplers 150-153, in turn, couples a portion of the combined pump energy output from 3 dB couplers 142 and 143 into each of two erbium doped optical fibers 102, 104 and into the first and second input optical transmission fibers 110, 120. In a first stage, each of the 3 dB couplers 140 and 141 combines the outputs of two optical pump sources 130 and 131, and 132 and 133, respectively. Each of the couplers 140 and 141 distributes one half of the respective combined output to each of two second stage 3 dB couplers 142, 143. In turn, each of the second stage 3 dB couplers 142, 143 combines two of the respective first stage outputs to provide combined outputs. One half of each respective combined output, is then distributed to each of two optical couplers 150, 153, and 151, 152, respectively. Coupler 150 couples a portion of the combined energy output from coupler 142 into the erbium doped fiber 102, while coupler 152 couples a portion of the combined energy output from coupler 143 into erbium doped fiber 104. As shown in FIG. 4, the pump energy is coupled in a reverse direction, i.e. an upchannel direction, into the output ends of the erbium doped fibers 102, 104.

In addition, coupler 151 couples a portion of the combined energy output from coupler 143 into the first input transmission fiber 110, while coupler 153 couples a portion of the combined energy output from the coupler 142 into the second input transmission fiber 120. Again, such pump energy is coupled in a reverse direction, i.e. an upchannel direction, into the output ends of the first and second input transmission fibers 110 and 120.

Owing to the fact that the output of all pump sources is combined by 3 dB couplers 140-143 and distributed to each of the two erbium doped fibers and the two transmission fibers, repeater amplification is provided which is tolerant to a failure of any of the pump sources 130-133. Stated another way, if one of the pump sources 130-133 fails, the outputs of the other three pump sources are still combined and distributed by the 3 dB couplers 140-143 and couplers 150-153 to each of the two erbium doped fibers and the two input transmission fibers. As a result, each of these fibers receives three fourths of the original pump energy. In the highly unlikely event that two pump sources were to fail, each of the fibers would still receive one half of the original pump energy.

Various modifications and alternative arrangements are possible with respect to the particular embodiment shown in FIG. 4. For instance, signals can be carried all in one direction on the optical transmission fibers 110, 112, 120 and 122, in which case corresponding changes are made in the direction in which optical pump energy is coupled by the couplers 150-153 to the doped fibers 102, 104 and input transmission fibers 110 and 120. In addition, the optical pump energy need not be coupled in the reverse direction, i.e., from the output ends, into the doped fiber sections 102, 104, as shown. In an alternative embodiment, the pump energy is coupled in the forward direction, i.e., in a downchannel direction, from the input ends 103, 105 into the doped fiber sections 102, 104. In addition, in an alternative embodiment of the invention, the pump energy is not coupled in an upchannel direction into the first and second input transmission fibers 110, 120, as shown in FIG. 4. Instead, in such alternative embodiment, such pump energy is coupled in the downchannel direction into the first and second output transmission fibers 112, 122.

In a particular embodiment as shown in FIG. 6, the four optical pump sources each have different center wavelengths λ_{C1}, λ_{C2}, λ_{C3}, and λ_{C4} which are each different from the other, the “center wavelength” being defined as the center of a range of wavelengths over which the highest power is output from the pump source. In addition, each of the center wavelengths preferably lies within a different range of wavelengths. For example, a first pump source has a center wavelength λ_{C1} within the range 1440-1450 nm, the second pump source has a center wavelength λ_{C2} within the range 1450-1460 nm, the third pump source a center wavelength λ_{C3}, within the range 1460-1470 nm, and the fourth pump source a center wavelength λ_{C4} within the range 1470-1480 nm.

Within each of the particular ranges of wavelengths, different approaches may be used to select pump sources for use within a repeater 100 according to embodiments of the invention. In one approach, pump sources having specific center wavelengths are selected for use in the repeater, e.g. 1445 nm, 1455 nm, 1465 nm, and 1475 nm. In such case, care must be taken to manufacture and sort pump sources having the specific center wavelengths, as variations in the manufacturing process tend to make the center wavelengths of the pump sources vary from lot to lot, and particularly within lots. Such approach to selection leads to many pump sources not meeting the selection criteria, in which case they must either be discarded or returned to the manufacturer for replacement.

In another, more preferred method, the pump sources are each selected at random from a group of pump sources having different wavelengths, such that the center wavelengths of the selected pump sources are distributed across a range of wavelengths, as determined by their random selection from the group of pump sources. Such random selection is appropriate to select pump sources having center wavelengths distributed across a range of wavelengths, because variations in manufacturing the pump sources causes their center wavelengths to vary in a random or seemingly random way. Desirably, the group of pump sources is large, e.g. greater than 20 pump sources, more preferably greater than 50, and most preferably about 100 pump sources or more in the group. As a result, using such selection method, the center wavelengths of the pump sources are distributed randomly across a range of wavelengths.

In a variation of the above approach, different groups of pump sources are provided, such that each group contains pump sources having center wavelengths within a certain nominal range of wavelengths. For example, a first group has center wavelengths which are nominally within the range 1440-1450 nm, a second group nominally within the range 1450-1460 nm, a third group nominally within the range 1460-1470 nm, and a fourth group nominally within the range 1470-1480 nm. The populating of each group with pump sources can be performed to an acceptable degree of imprecision, as the blending of the outputs of the pump sources spreads the combined energy output over a broader range of wavelengths. Moreover, when the repeater is one of many repeaters in an optical transmission system, as described below with respect to FIG. 8, variations among the repeaters in the system tend to be averaged over the transoceanic and intercontinental distances traversed by the system. Accordingly, some of the pumps in a group of pumps may have wavelengths that fall outside of the nominal ranges of wavelengths, and may actually overlap with the nominal wavelength range of another group. According to the embodiments of the invention, this imprecision is acceptable as a way of increasing the number of pump sources that meet acceptance criteria and permitting reduced test precision. In addition, according to this method, the stocking of pump sources is simplified and the cost of obtaining pump sources for use in a repeater or optical transmission system may be lowered due to the relaxed acceptance and text criteria.

As an example of such approach, when the optical repeater 100 includes four pump sources, one pump source is randomly selected from each of the four groups. As a result, the optical repeater 100 is assured of having pump sources in each of four nominal ranges of wavelengths, while permitting each pump source to be randomly selected from each particular group. In addition, selection according to this method avoids requiring the center wavelength of each pump source to be tightly controlled.

As the pump sources have center wavelengths that are distributed across a range of wavelengths, the combined pump energy output of the coupler 140 has a flattened spectrum, appearing as shown at 160 in FIG. 6. Such flattened output spectrum is well adapted for use in an optical repeater 100 used for wave-division multiplexed signals. The flattened spectrum operates to produce a flattened gain profile in the erbium doped fibers 102, 104 and a flattened Raman gain profile in the transmission fibers 110, 120.

In a further variation of the embodiment shown in FIG. 4, a number of pump sources greater than four (e.g. six pump sources) are provided. In such case, portions of the output of each pump source are combined by 3 dB couplers at each stage and the outputs of each stage are combined and distributed to a further stage, until portions of the output of all the pump sources have been combined and distributed by end stage 3 dB couplers. Coupler 140 accepts input from all six of the pump sources, and combines the outputs of all of the pump sources. Combined portions are then distributed to each of the couplers 150-153, which, in turn, couple the energy into each of the erbium doped fibers 102, 104 and the transmission fibers 110, 120, respectively.

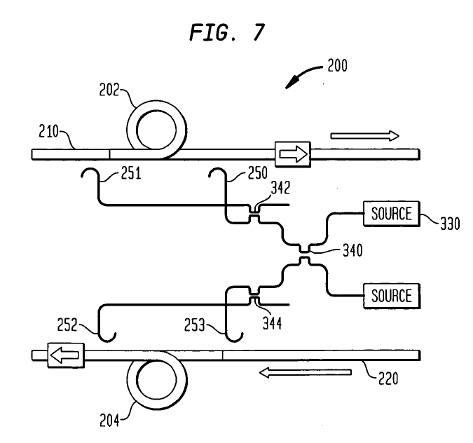

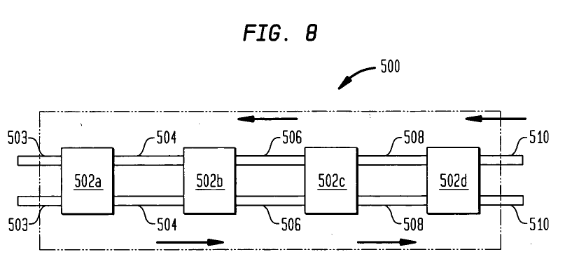

FIG. 7 illustrates an optical repeater 200 according to another embodiment of the invention. In such embodiment, the repeater has only a pair of optical pump sources 330. The optical pump sources 330 each have different center wavelengths, such that a flattened or blended power spectrum results. The outputs of the two pump sources 330 are combined and distributed to the respective erbium doped fibers and transmission fibers by the 3 dB couplers 340, 342 and 344, in a manner similar to that described above with respect to FIG. 4.

FIG. 8 illustrates an optical transmission system 500 in which a plurality of optical repeaters 502a-502d are provided, each optical repeater being arranged at ends of transmission fibers. That is, an optical repeater 502a is coupled to the ends of the pairs of transmission fibers 503, and 504. Similarly, the optical repeater 502b is coupled to the ends of the pairs of transmission fibers 504, and 506, while the optical repeater 502c is coupled to the ends of the pairs of transmission fibers 506, and 508, and so on.

It is characteristic of repeaters having rare earth element doped fiber amplifiers, especially erbium doped fiber amplifiers, to amplify optical signals to a point at which a relatively fixed output signal power level is attained. However, the output signal power level is a function of the power that is input to the erbium doped fiber amplifier from optical pump source(s). Thus, even in repeaters according to the above embodiments which continue to pump the erbium doped fibers and transmission fibers, if one of the pump sources used to power a particular optical repeater fails, the output signal power level of that repeater falls. However, the optical transmission network 500 having a plurality of optical repeaters makes up for such drop in output signal power. In such network, when a pump source fails in one repeater, e.g. repeater 502b, somewhat lower output signal power is driven on the transmission fibers 504 and 506 to the next repeaters 502a and 502c coupled thereto, respectively. However, the next repeaters 502a, 502c in each direction of propagation in the network amplify the signals to the relatively fixed output signal power level, which then restores the transmitted signals to a desirable output power level.

The optical transmission system 500 is adapted to be used for long-haul transmission service across remote locations, such as undersea locations, e.g. crossing large bodies of water including oceans, seas and lakes, underground, across geographically remote locations, and in locations of weather extremes. At least the repeaters 502a-502d, and desirably both the repeaters and the transmission fibers 503-510 of the optical transmission system are, enclosed by sheathing, such sheathing providing long-term protection from conditions in such remote locations. When the optical transmission system 500 is placed in such use, the repeaters described above with respect to FIGS. 4 through 7 are so constructed to permit operation of such system, uninterrupted by failure of an optical pump source in any one repeater, over the useful life of the system.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An optical repeater operable to amplify signals propagated by a pair of optical transmission fibers, comprising:
a first rare earth element doped (REED) fiber coupled to a first transmission fiber of the pair of optical transmission fibers;
a second rare earth element doped (REED) fiber coupled to a second transmission fiber of the pair of optical transmission fibers;
at least four optical pump sources;
one or more optical energy couplers coupled to combine portions of the outputs of all said optical pump sources and to distribute the combined portions for insertion into each of said first and second REED fibers for amplification of signals thereby, and into each of the first and second transmission fibers for Raman amplification of signals thereby.

2. An optical repeater as claimed in claim 1, wherein the combined portions are inserted into said first and second REED fibers in a downchannel direction.

3. An optical repeater as claimed in claim 1, wherein the combined portions are inserted into said first and second REED fibers in an upchannel direction.

4. An optical repeater as claimed in claim 1, wherein the combined portions are inserted into said first and second transmission fibers in a downchannel direction.

5. An optical repeater as claimed in claim 1, wherein the combined portions are inserted into said first and second transmission fibers in an upchannel direction.

6. An optical repeater as claimed in claim 1, wherein said optical pump sources include pump sources selected from the group consisting of lasers and laser diodes.

7. An optical repeater as claimed in claim 1, wherein said REED fibers include erbium doped fibers.

8. An optical repeater as claimed in claim 1, wherein the first transmission fiber is arranged to propagate first signals thereon in a first direction and the second transmission fiber is arranged to propagate second signals thereon in a second direction different from the first direction.

9. An optical repeater as claimed in claim 8, wherein the second direction is opposite the first direction.

10. An optical repeater as claimed in claim 1, wherein the outputs of said at least four optical pump sources have at least four different center wavelengths.

11. An optical repeater as claimed in claim 1, wherein the output of each said optical pump source has a center wavelength different from that of any other of said optical pump sources.

12. An optical repeater as claimed in claim 1, wherein said optical pump sources are selected such that the outputs of said optical pump sources have center wavelengths in each of a plurality of selected ranges of wavelengths.

13. An optical repeater as claimed in claim 12, wherein each of said optical pump sources is selected randomly from respective groups of said optical pump sources, wherein each said optical pump source within said respective group is operable to provide output at a center wavelength in a particular one of said selected ranges of wavelengths.

14. An optical repeater as claimed in claim 1, wherein said optical pump sources are selected to provide outputs at each of a plurality of selected center wavelengths.

15. An optical repeater as claimed in claim 1, wherein the combined portions have a flattened spectrum relative to wavelength, such that a flattened gain profile is produced in said REED fibers and said transmission fibers.

16. An optical transmission system including a plurality of optical repeaters as claimed in claim 1 and a plurality of pairs of the optical transmission fibers, each said optical repeater being arranged at an end of at least one of the pairs of optical transmission fibers, said optical transmission system adapted to produce a gain profile which remains substantially unchanged despite a failure to provide output by one of said optical pump sources of an optical repeater of said plurality of optical repeaters.

17. An optical transmission system as claimed in claim 16 further comprising sheathing enclosing said repeaters, adapted to provide long-term protection from conditions in remote locations.

18. An optical transmission system as claimed in claim 16 further comprising sheathing enclosing said repeaters and said optical transmission fibers, adapted to provide long-term protection from underwater conditions.

19. An optical transmission system as claimed in claim 16, wherein said first and second REED fibers are adapted to amplify the signals to a predetermined level, regardless of levels of the signals input to each said REED fiber.

20. The optical repeater of claim 1, wherein said one or more optical energy couplers includes first, second, third, and fourth 3 dB couplers, wherein the outputs of a first group of two of said optical pump sources are coupled to said first 3 dB coupler, the outputs of a second group of two of said optical pump sources are coupled to said second 3 dB coupler, and portions of the outputs of said first 3 dB coupler and said second 3 dB coupler are combined and distributed by each of said third and fourth 3 dB couplers.

21. An optical repeater operable to amplify signals propagated by a pair of optical transmission fibers, comprising:
a first rare earth element doped (REED) fiber coupled to a first transmission fiber of the pair of optical transmission fibers;
a second rare earth element doped (REED) fiber coupled to a second transmission fiber of the pair of optical transmission fibers;
a plurality of optical pump sources each having a center wavelength different from that of any other of said optical pump sources; and
an optical energy coupler coupled to combine portions of the outputs of all said optical pump sources and to distribute the combined portions for insertion into each of said first and second REED fibers for amplification of signals thereby, and into each of the first and second transmission fibers for Raman amplification of signals thereby.

22. An optical repeater as claimed in claim 21, wherein said optical pump sources are selected such that the outputs of said optical pump sources have center wavelengths in each of a plurality of selected ranges of wavelengths.

23. An optical repeater as claimed in claim 21, wherein each of said optical pump sources is selected randomly from respective groups of said optical pump sources, wherein each said optical pump source within said respective group is operable to provide output at a center wavelength in a particular one of said selected ranges of wavelengths.

24. An optical repeater as claimed in claim 21, wherein the combined portions have a flattened spectrum relative to wavelength, such that a flattened gain profile is produced in said first and second portions REED fibers and said first and second transmission fibers.

25. An optical transmission system including a plurality of optical repeaters as claimed in claim 21 and a plurality of pairs of the optical transmission fibers, each said optical repeater being arranged at an end of at least one of the pairs of optical transmission fibers, said optical transmission system adapted to produce a gain profile which remains substantially unchanged despite a failure to provide output by one of said optical pump sources of an optical repeater of said plurality of optical repeaters.
